(19) United States
(12) Patent Application Publication
(10) Pub. No.: US 2024/0200406 A1
(43) Pub. Date: Jun. 20, 2024

(54) Tree Climbing Apparatus

(71) Applicant: Tree Styx L.L.C., South Lyon, MI (US)

(72) Inventor: James Charles Hanshaw, South Lyon, MI (US)

(73) Assignee: Tree Styx L.L.C., South Lyon, MI (US)

(21) Appl. No.: 18/542,125

(22) Filed: Dec. 15, 2023

Related U.S. Application Data
(60) Provisional application No. 63/432,712, filed on Dec. 15, 2022.

(51) Int. Cl. E06C 1/58; A01M 31/02; E06C 1/34; E06C 1/38; E06C 7/08; E06C 7/16; E06C 7/48; E06C 7/50

(52) U.S. Cl. CPC E06C 1/58; A01M 31/02; E06C 1/34; E06C 1/381; E06C 7/08; E06C 7/165; E06C 7/48; E06C 7/50

(57) ABSTRACT

Embodiments of tree climbing sticks adapted to be secured to a tree and provide a tree climbing assist are provided. In one embodiment, for example, a tree climbing stick is provided including a retractable aider step. The retractable aider step is adapted to be extended from the tree climbing stick during use and at least partially retracted within the tree climbing stick for transport and storage. In another embodiment, a tree climbing stick is adapted to be stacked and nested with another tree climbing stick. In this embodiment, a clip of the tree climbing stick is adapted to engage a button of an adjacent tree climbing stick and standoffs of the tree climbing sticks are adapted to nest so that the tree climbing sticks can be stacked vertically without axially extending from each other.

### BACKGROUND

### Field

The instant disclosure relates to a tree climbing stick.

### Background

Climbing sticks are an aide to assist climbing a tree primarily to a fixed position. They include multiple independent sections with two or three steps, secured to a tree, and allow the user to climb to the desired height.

Climbing sticks come in a variety of step distances which is dependent on the users preference. A two-step climbing stick with a 20″ step distance, for example, will allow the user to ascend 40″ per stick, (20″ to the first step and 20″ to the second step). A typical hunting height is twenty feet and would require six climbing sticks. In order to reduce the number of climbing sticks transported and installed, an additional step made from webbing or rope, called an aider, can be used to add length to the climbing stick. Because the aider is typically not an integral part of the climbing stick it needs to be installed each use which is time consuming or wrapped up when transported which is bulky. Having an integral aider that is the same step distance as the stick step distance adds an extra 20″ in this example and allows the user to achieve the typical 20′ hunting height with only 4 climbing sticks.

Additionally, the transportation and installation of the climbing sticks is something important to hunters and often overlooked by manufacturers. Having the climbing sticks nest within one another with materials that don't make metallic sounds that also limit axial motion and are retained with integral clips is an advantage. Typically, the first climbing stick is installed to the tree and the rest are individually fastened to the user's climbing belt, making for a noisy complicated climb. Having an integral retaining clip allows the user to keep the remainder of the sticks stacked on top of one another as they ascend the tree.

### BRIEF OVERVIEW

In one embodiment, a tree climbing stick comprising a retractable aider is provided. A stick body comprises an elongated member comprising an upper end, a lower end, and a longitudinal axis extending through the upper end and the lower end of the stick body. The stick body comprises an interior opening extending through the lower end along at least a portion of the longitudinal axis. A first standoff is attached to and extends away from the stick body in a first direction. A second standoff is attached to and extends away from stick body in the first direction. The second standoff is spaced from the first standoff, and the first and second standoffs are adapted to engage a tree and maintain the stick body in a spaced relationship with the tree. A step is attached to the stick body and extends outwardly from the stick body. The step comprises a step interior opening extending through at least a portion of a length of the step. A retractable aider step comprises a loop extending below the step and through the step interior opening and a pull handle coupled to the loop within at least one of the stick body interior opening and the step interior opening. The pull handle extends from at least one of the steps and the stick body, and the aider step is adapted to be extended by a user pulling the loop and to be retracted by the user pulling the pull handle.

In another embodiment, a tree climbing stick is adapted to be stacked and secured to a second tree climbing stick. A stick body comprises an elongated member comprising an upper end, a lower end, and a longitudinal axis extending through the upper end and the lower end. A connection member comprises a button coupled to and extending from the stick body in a first direction and a clip extending from the stick body in a second opposite direction. A first standoff is attached to and extends away from the stick body in the second direction. A second standoff is attached to and extends away from stick body in the second direction. The second standoff is spaced from the first standoff. The first and second standoffs are adapted to engage a tree and maintain the stick body in a spaced relationship with the tree. A first step is attached to the stick body and extends outwardly from the stick body. The first step is disposed distally along the stick body longitudinal axis relative to the first standoff. A second step is attached to the stick body and extends outwardly from the stick body. The step is disposed distally along the stick body longitudinal axis relative to the second standoff. The clip of the connection member is adapted to secure a button of a second tree climbing stick. The first and second standoffs are adapted to nest with a respective first and second standoff of the second tree climbing stick when the tree climbing stick is coupled with the second tree climbing stick.

In this embodiment, a second tree climbing stick can be provided. The second tree climbing stick comprises a second stick body comprising a second elongated member having a second upper end, a second lower end, and a second longitudinal axis extending through the second upper end and the second lower end. A second connection member comprises a second button coupled to and extending from the second stick body in a third direction and a second clip extending from the stick body in a fourth direction opposite the third direction. A second stick first standoff is attached to and extends away from the second stick body in the fourth direction. A second stick second standoff is attached to and extends away from second stick body in the fourth direction. The second stick second standoff is spaced from the second stick first standoff and the second stick first and second standoffs are adapted to engage a tree and maintain the second stick body in a spaced relationship with the tree. A second stick first step are attached to the second stick body and extend outwardly from the second stick body. The second stick first step is disposed distally along the second stick body second longitudinal axis relative to the second stick first standoff. A second stick second step is attached to the second stick body and extends outwardly from the second stick body. The second stick second step is disposed distally along the second stick body second longitudinal axis relative to the second stick second standoff. The second button is adapted be engaged by the clip of the connection member, and the first and second standoffs are adapted to nest with the respective second stick first and second standoffs of the second tree climbing stick when the tree climbing stick is coupled with the second tree climbing stick.

In another embodiment, a tree climbing stick is provided comprising an integral button and clip connection member. In this embodiment, a stick body comprises an elongated member comprising an upper end, a lower end, and a longitudinal axis extending through the upper end and the lower end. A connection member comprises an integral button and clip device coupled to the stick body. The integral button and clip device comprises a button extending from the stick body in a first direction, and a clip extending around and away from the stick body in a second opposite direction. A first standoff is attached to and extends away from the stick body in the second direction. A second standoff is attached to and extends away from stick body in the second direction. The second standoff is spaced from the first standoff, and the first and second standoffs are adapted to engage a tree and maintain the stick body in a spaced relationship with the tree. A first step is attached to the stick body and extends outwardly from the stick body. The first step is disposed distally along the stick body longitudinal axis relative to the first standoff. A second step is attached to the stick body and extends outwardly from the stick body. The second step is disposed distally along the stick body longitudinal axis relative to the second standoff. The clip of the integral button and clip device is adapted to engage a button of a second tree climbing stick.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a perspective view of an example embodiment of a climbing stick.

FIG. 2 is a front plan view of the climbing stick of FIG. 1 with an aider step positioned in a fully retracted, stowed position.

FIG. 3 is a front plan view showing the climbing stick of FIG. 1 with the aider step positioned in a fully extended, climbing position.

FIG. 4 is a schematic view showing internal and external features of an embodiment of an aider step of a climbing stick in a fully extended, climbing position.

FIG. 5 is a schematic view showing internal and external features of the aider step shown in FIG. 4 in of a climbing stick in a fully retracted, stowed position.

FIG. 6 shows an embodiment of a pair of nested, stacked climbing sticks.

FIG. 7 shows an expanded view of a pair of brackets of the nested, stacked climbing sticks shown in FIG. 6.

FIG. 8 is another perspective view of the nested, stacked first and second climbing sticks shown in FIG. 6.

FIGS. 9A and 9B show another embodiment of a button and clip device for use on a climbing stick.

FIG. 10 is a perspective view of an integral step and standoff device.

FIG. 11 is a schematic view showing an embodiment of an adjustable length climbing stick allowing for an adjustable climbing stick step distance.

FIG. 12 is a schematic diagram showing an embodiment of an adjustable length integrated retractable aider step.

FIG. 13 is a perspective view of a climbing stick including a removable, field installed angled shelf attached directly to a climbing stick.

FIG. 14A is a top view showing an angled shelf attached to a top step of a climbing stick.

FIG. 14B is a top view showing an angled shelf partially attached to a top step of the climbing stick.

FIG. 15 is a front view of a plurality of climbing sticks secured to a tree to provide a climbing aid to climb the tree.

### DETAILED DESCRIPTION

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a” component can include two or more such components unless the context indicates otherwise. Also, the words “proximal” and “distal” are used to describe items or portions of items that are situated closer to and away from, respectively, a user or operator such as a surgeon. Thus, for example, the tip or free end of a device may be referred to as the distal end, whereas the generally opposing end or handle may be referred to as the proximal end.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The term “substantially” or “generally” as used herein may be applied to modify any quantitative representation which could permissibly vary without resulting in a change in the basic function to which it is related.

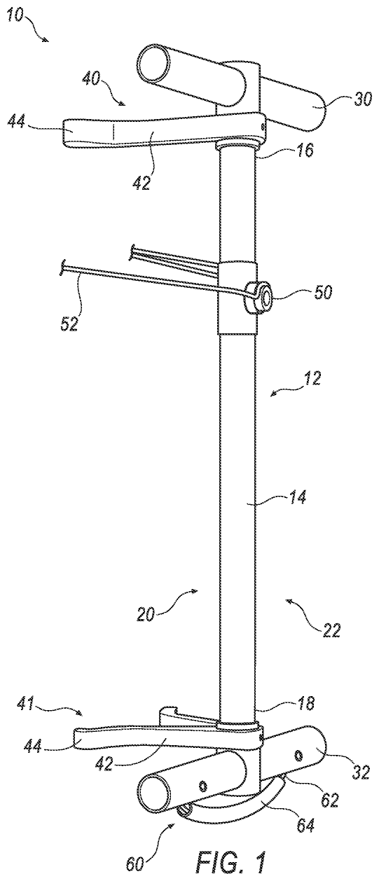

FIG. 1 is a perspective view of an example embodiment of a climbing stick 10. In this embodiment, the climbing stick 10 comprises a stick body 12. The stick body 12 comprises an elongated member 14 having a first, upper end 16 and a second, lower end 18. The stick body 12 further has a first, tree-facing side 20 and a second, user-facing side 22. The stick body 12 may comprise any conventional materials used for tree climbing stick devices including strong and lightweight materials, such as metal alloys, plastics, carbon fiber, and the like.

The climbing stick 10 comprises a pair of steps 30, 32 disposed at opposing ends of the stick body 12. The steps 30, 32 are used for both stepping upon and gripping by a person using the climbing stick to climb a tree and may also be referred to as a handhold. In this embodiment, the steps 30, 32 comprise generally tubular members that are disposed in a generally perpendicular orientation to the stick body 12 as shown in FIG. 1. Although the steps 30, 32 are shown as smooth tubular members in FIG. 1, the steps may further include protrusions or other friction enhancing surfaces (e.g., lining) to enhance friction between the step 30, 32 and the user's footwear and hands.

The climbing stick 10 further comprises a pair of standoffs 40 attached to the stick body 12. In this embodiment, for example, each standoff 40 comprises a bracket 42 and a pair of feet 44. The standoffs 40 extend away from the first, tree-facing side 20 of the stick body 12 and are adapted to engage the tree and maintain the stick body in a spaced relationship with the tree. The bracket defines an opening between the feet adapted to receive a curved portion of a tree trunk between the feet of the standoff. In the embodiment shown in FIG. 1, for example, the bracket 42 of each standoff 40 is disposed along the stick body inwardly of a respective one of the steps 30. The feet 44 may include one or more protrusions or friction enhancing surfaces (e.g., cleats, rubber pads) to frictionally engage a tree trunk in use.

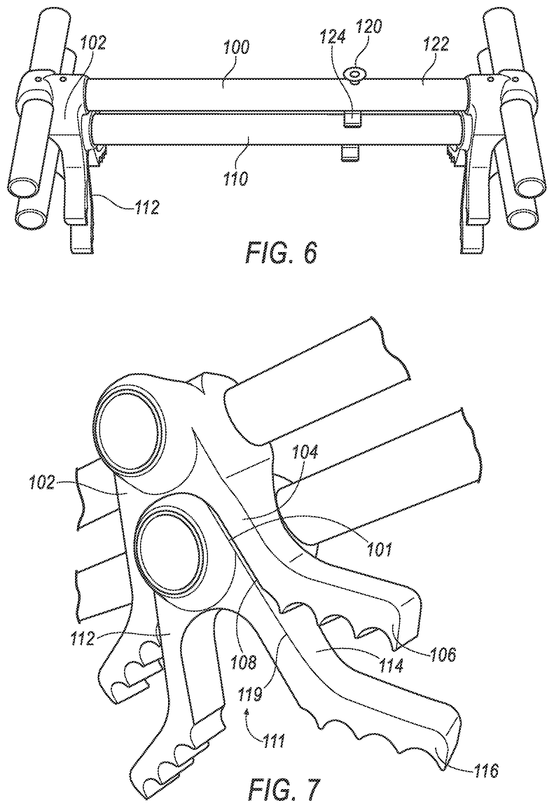

The climbing stick also comprises a button 50 attached to and extending from the stick body 12. The button 50 is utilized for attachment of the climbing stick to a tree by extending a tether 52 (e.g., a rope or cable) around the tree and securing the tether to the button 50. The button may further comprise a clip adapted to engage the stick body of an adjacent climbing stick when stacked and secured together so as to stabilize stacked climbing sticks and mute sound from their abutment when they are secured together, such as shown in FIG. 6 and described below.

The climbing stick further comprises a retractable aider step 60. In this embodiment, for example, the aider step comprises a cable or rope 62 that is adapted to be at least partially extended from or retracted within the stick body 12 and/or the lower step 30. The aider step further comprises a generally tubular aider step member 64 disposed about a bottom portion of a loop 66 of the cable or rope 62. The generally tubular aider step member 64 may be rigid or generally flexible, but is adapted to maintain a width of the aider step at the bottom portion of the cable or rope and provides a step surface for a user's footwear. The member 64 may also comprise a plurality of protrusions or another friction enhancing surface to reduce the tendency of the user's footwear from slipping on the member 64. By spreading the bottom loop 66 of the aider step, the generally tubular aider step member 64 maintains the aider step in a generally open configuration from the lower step 30 to the generally tubular aider step member 64 (e.g., rubber tubing). The open configuration makes it easier for a user to find the aider step during use (e.g., climbing a tree in the dark while looking upward). The aider step, in one embodiment comprises substantially the same length as the distance between the bottom and top steps 30 maintaining a consistent step distance when in use. The generally tubular aider step member 64 may also comprise a generally flexible material that may frictionally engage at least a portion of the lower step in a fully retracted position to reduce or eliminate noise generated by the abutment of the aider step 60 and the lower step 30, such as while being carried by a hunter.

The stick body, in one embodiment, comprises carbon fiber. In other embodiments, the stick body may comprise aluminum, steel or titanium tubing. However, other materials may also be used. In one embodiment, the button comprises a steel round weld nut such as sold by McMaster Carr and may be coupled with a clip secured with a bolt or other connector. The button and/or split pin may comprise steel or another metal material in some embodiments.

In one embodiment, the aider step cord and tether comprises an ultra-high molecular weight polyethylene cord, such as a rope made from a Dyneema™ material produced by Avient Corporation and sold under the tradename Amsteel Blue™ by Samson Rope technologies. Other materials may include, for example, paracord (parachute cord) or a fiber called Spectra solid sold under the name DynaGlide™. The aider step outer tubing may comprise an EPDM rubber air hose or a neoprene hose. The pull cord for retracting the aider step may comprises an Amsteel Blue™ or spectra rope or other material that allows for coupling to the aider step loop and smoothly wrap around the button pin or other internal structure of the climbing stick. In one embodiment, for example, the aider step pull cord comprises a 12 strand Amsteel Blue™ rope with a locked brummel loop. These materials, however, are merely examples and other materials may be used.

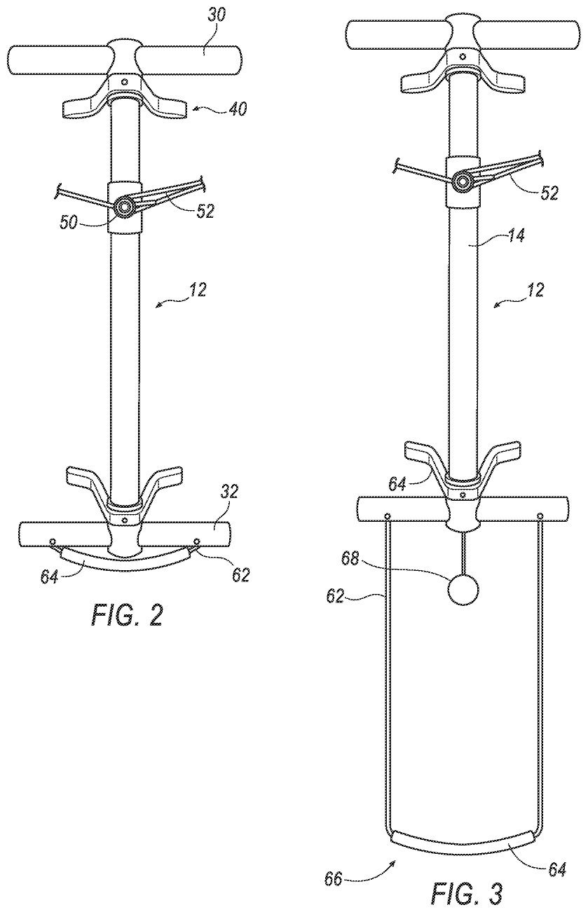

FIGS. 2 and 3 are front plan views showing the climbing stick 10 of FIG. 1 with the aider step 60 positioned in a fully retracted, stowed position in FIG. 2 and a fully extended, climbing position in FIG. 3. As can be seen in FIG. 2, the cable or rope 62 of the aider step 60 is adapted to be fully retracted within a housing (e.g., within the stick body 12, the upper step 30, and/or the lower step 30) of the climbing stick 10 other than the dimension of the generally tubular aider step member 64. The aider step is adapted to be operated with a single hand, such as by pulling the lower generally tubular aider step member 64 to extend the aider step from the housing of the climbing stick 10 or by pulling the handhold that may be operated with a single hand by pulling the pull rope 68 to retract the aider step within the climbing stick 10 housing.

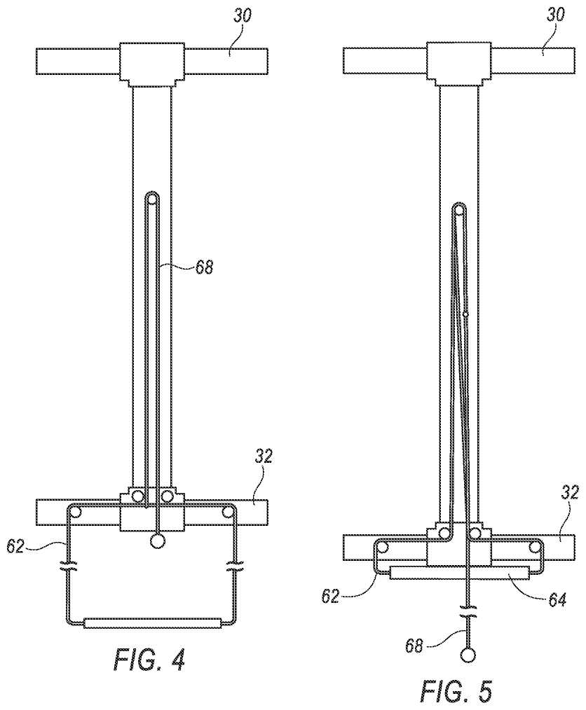

FIGS. 4 and 5 are schematic views showing internal and external features of an embodiment of the aider step 60 of the climbing stick 10 shown in FIGS. 1 through 3. In this embodiment, for example, the aider step comprises a closed loop 66 formed by the cable or rope 62 about which the lower generally tubular aider step member 64 is disposed at a bottom portion of the closed loop. The closed loop extends at least partially through the lower step 30 of the climbing stick 10 housing. In this embodiment, for example, the closed loop 66 is disposed about a pair of pins located within the lower step 30 of the climbing stick 10. Alternatively, the closed loop 66 may enter the lower step 30 through openings formed in a surface of the step or at open ends of the step 30 and extend through the tubular interior of the lower step 30 A pull rope 68 is secured to a portion of the continuous loop within the housing of the climbing stick. The pull rope 68 is further looped about a pin or other structure within the housing of the climbing member and extends out of the housing to provide a pull loop 70 for retraction of the aider step.

In operation, the aider step 60 is extended from the climbing stick 10 housing by pulling the aider step member away 64 from the lower step 30 until the continuous loop 66 is fully extended from the housing and the pull rope 68 is fully extended within the housing as shown in FIG. 4. The aider step 60 is retracted by pulling a pull loop formed at a proximal end of the pull rope 68 down and away from the housing. The pull rope 68 is looped around the pin of the button 50 (or another structure within the housing) and connected to the closed loop at a distal end 72 of the pull rope 68. By withdrawing the pull rope 68 from the housing, the pull rope 68 pulls the closed loop 66 up and within the housing (e.g., within an opening of a hollow stick body 12) retracting the tubular aider step member 64 to the fully retracted stowed position adjacent to a lower surface of the lower step 30 as shown in FIG. 5.

In another embodiment, a single continuous loop may extend over a button pin disposed within the stick body of the climbing stick and extend out through the bottom step of the climbing stick to form an integral pull rope. In this embodiment, pulling the end of the continuous loop retracts a lower portion of the continuous loop within the housing of the climbing stick and brings the aider step formed by that continuous loop up to the lower step of the climbing step. In this embodiment, the continuous loop and pull rope shown in FIGS. 4 and 5 are combined into a single element. However, since the aider step is load bearing, the single, integral continuous loop and pull rope should be sized sufficiently to be load bearing. In the embodiment shown in FIGS. 4 and 5, however, only the continuous loop forming the aider step need be load bearing and the pull rope may be sized smaller than would otherwise be needed to be load bearing.

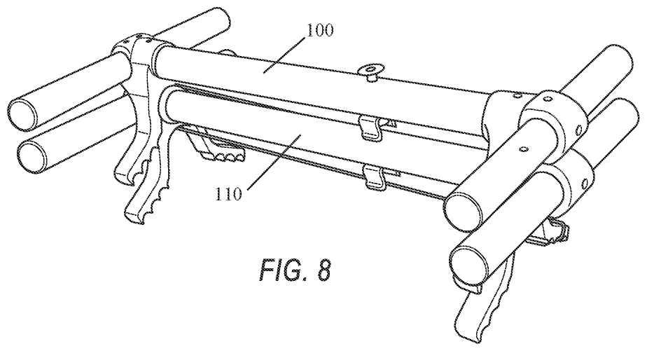

FIG. 6 shows an embodiment of a pair of nested, stacked climbing sticks 100, 110. FIG. 7 shows an expanded view of a pair of brackets 102, 112 of the nested, stacked claiming sticks 100, 110. FIG. 8 is another perspective view of the nested, stacked first and second climbing sticks 100, 110.

The climbing sticks 100, 110 stack in an aligned position in which the exterior dimensions of the first climbing stick 100 and the second climbing stick 110 are generally aligned so that the sticks 100, 110 are arranged in a compact manner. In this embodiment, the steps and brackets of the climbing sticks 100, 110 are aligned with each other and neither climbing stick extends beyond the outer dimensions of the adjacent climbing stick.

In one embodiment, for example, a first bracket 102 of the first climbing stick 100 defines a first opening 101 disposed between a first pair of bracket members 104 and a first pair of feet 106 of the bracket 102. A second bracket 112 of the second climbing stick 110 similarly defines a second opening 111 disposed between a second pair of bracket members 114 and a second pair of feet 116 of the second bracket 112. An interior surface 108 of the first bracket 100 is generally complementary to an outer surface 119 of the second bracket 110 such that the second bracket 112 nests and stacks within the opening of 101 the first bracket 102. In one embodiment, for example, the interior surface 108 of the first bracket 102 has an angled surface that is generally the same as an angled outer surface 119 of the second bracket allowing the second bracket 110 to slide within the opening 101 of the first bracket 102. Further, an outer dimension of the proximal end of the bracket 112 of the second climbing stick 110 is generally the same as an inner dimension of the proximal end of the opening 101 defined by the first bracket 102 of the first climbing stick 100.

As shown in FIG. 6, a button 120 of the first climbing stick 100 extends outwardly from a stick body of the first climbing stick 100 through the stick body 122 and is coupled to a clip 124 that extends away from the stick body in an opposite direction than the button. The button, for example, may comprise a split pin or bolt with a head of the pin or bolt forming the button for securing the climbing stick to a tree in which the button extends in a direction opposite from the tree in use. The clip on the other hand extends generally toward the direction of the tree in use (e.g., extending in the same direction as the standoff bracket and feet. The clip is adapted to secure the first climbing stick body to the second climbing stick body by engaging the second climbing stick body. The second climbing stick also comprises a similar button, pin, and clip to secure the second climbing stick to a third climbing stick and so on.

The relative location of the tree bracket and feet disposed inwardly of the steps of the climbing sticks abut the steps of the adjacent, stacked climbing sticks and restricts axial movement of the stacked climbing sticks with respect to each other.

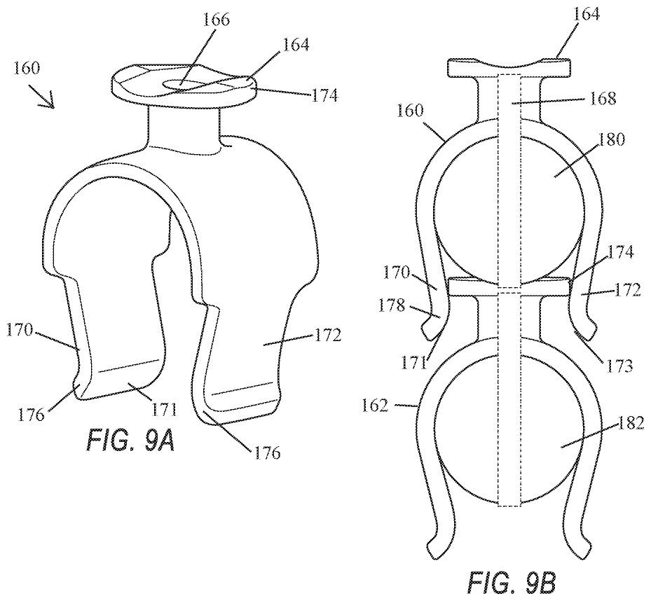

FIGS. 9A and 9B show another embodiment of a button and clip device 160 for use on a climbing stick. FIG. 9A shows a perspective view of an integral button and clip device 160, and FIG. 9B shows a pair of integral button and clip devices 160, 162 each secured around a stick body 180, 182 of one of a pair of climbing sticks in a nested, stacked configuration.

In this embodiment, the integral button and clip device 160 comprises an integral device including a button 164 comprising an opening 166 for a pin 168 to secure the device to a stick body 180 of a climbing stick. The integral button and clip device 160 may, for example, be formed of a single material (e.g., molded as a single piece). In one embodiment, the pin 168 is secured to the integral button and clip device 160 and the stick body 180 by a press fit. In this embodiment, the pin may comprise a split pin designed to stay in place when inserted into a bore. The integral button and clip device 160 further comprises a pair or resilient flanges 170, 172 that extend beyond the opposing side of the stick body 180. The pair of flanges 170, 172 comprise curved interior surfaces 171, 173 that flare outwardly as shown in FIGS. 9A and 9B. The flanges 170, 172 are adapted to engage an outer surface 174 of a button 164 of a second integral button and clip device 162 of a second climbing stick as shown in FIG. 9B. In operation, as the climbing sticks are stacked, an interior surface 171, 173 of each of the resilient flanges 170, 172 of a first integral button and clip device 160 contact an exterior surface 174 of the adjacent button of the second integral button and clip device 162. As the climbing sticks are pressed together, the interior surfaces 171, 173 of the flared portions 176 of the flanges 170, 172 contact the exterior surface 174 of the adjacent button of the second climbing stick and flex outwardly as the flanges 170, 172 are pressed over the adjacent button exterior surface 174. As the exterior surface 174 of the adjacent button is disposed inside the curved portion 178 of the flanges 170, 172, the resilient flanges 170, 172 return to their initial configuration and clip the button exterior surface 174 of the second climbing stick within an opening of the first integral button and clip device 160 of the first climbing stick.

In one embodiment, the clip or integral button and clip device comprises a carbon fiber reinforced thermoplastic. In other embodiments, the clip or integral button and clip device comprises a polymer such as nylon or a metal material such as a forged metal. Three-dimensional plastics or other materials may also be used.

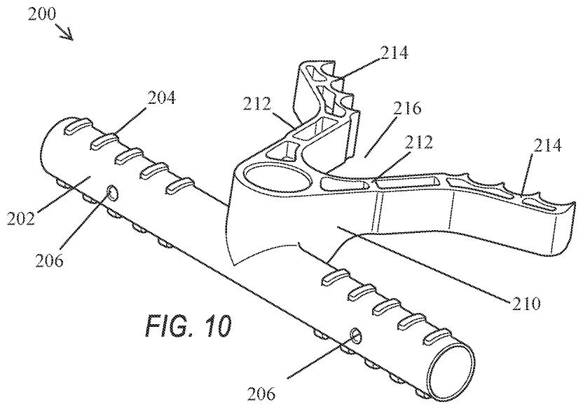

FIG. 10 is a perspective view of an integral step and standoff device 200. In this embodiment, the integral step and standoff device 200 may comprise a single integrally formed component, such as a molded component. In this embodiment, the integral step and standoff device 200 comprises an at least partially hollow step 202 including a plurality of protrusions adapted to enhance friction with a user's hands or footwear in use. The step 202 further comprises a pair of openings 206 adapted to receive a rope or cable of an aider step as described above with respect to FIGS. 2 through 5.

The integral step and standoff device 200 further comprises a tree bracket 210 comprising a pair of bracket members 212 and a pair of bracket feet 214 that collectively define an opening 216 adapted to stack and nest with another standoff member of an adjacent, stacked climbing stick, such as shown in FIG. 7. The integral step and standoff member 200 may be attached to varying length stick bodies to change the overall length of the climbing stick and the respective step distance for each climbing stick. Where the integral step and standoff device 200 is manufactured from a polymer (e.g., injection molded polymer), the sound caused by adjacent components can be limited when compared to metal or other materials. In one embodiment, for example, the integral step and standoff device may comprise an injection molded carbon fiber reinforced thermoplastic. Other examples include, but are not limited to, forged carbon fiber or other polymers.

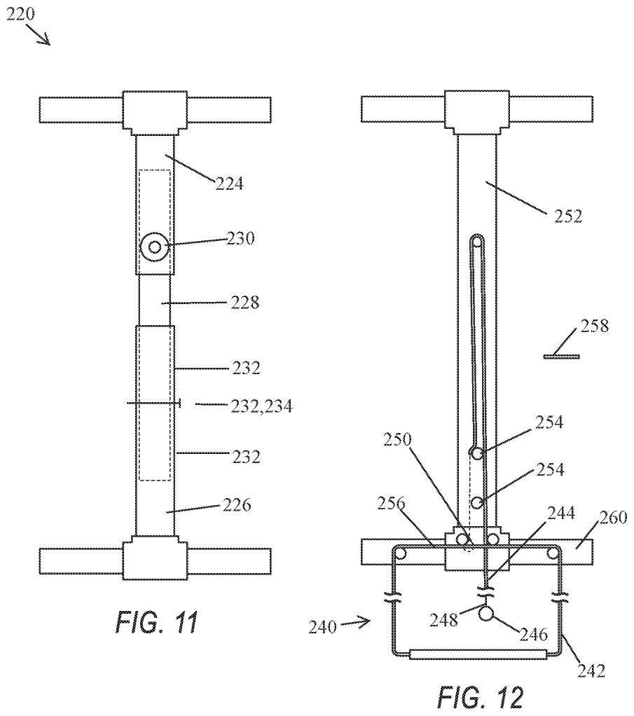

FIG. 11 is a schematic view showing an embodiment of an adjustable length climbing stick 220 allowing for an adjustable climbing stick step distance. In this embodiment, the stick body 222 comprises a pair of relatively larger diameter end tubes 224, 226, and an inner, relatively smaller diameter middle tube or solid cylinder 228. The inner tube or cylinder 228, in this embodiment, is disposed concentrically within each of the pair of end tubes 224, 226. The inner tube 228 may be fixed within a first one of the pair of end tubes 224, 226. For example, the inner tube 228 may be fixed concentrically within an upper end tube 224, such as via a split pin of a button device 230 as shown in FIG. 11. The inner tube 228 is also arranged in a telescoping concentric arrangement within one of the end tubes 224, 226, such as the lower end tube 226 shown in FIG. 11. In this embodiment, at least one of the larger diameter end tubes 224, 226 and the smaller diameter telescoping inner tube 228 comprises a plurality of holes 232 disposed within the respective tube. The remaining one of the tubes has at least one hole 232 disposed within the remaining tube. Each of the plurality of holes 232 of at least one of the tubes corresponds to one of plurality of climbing stick lengths that may be selected. A pin 234 is inserted through respective holes 232 of the tubes to secure the tubes in a selected, predetermined length. The pin 234 may be secured within the holes, such as via a quick release pin, a locking retaining pin, a cotter pin, a linch pin, a clip, a bolt and nut, or the like.

FIG. 12 is a schematic diagram showing an embodiment of an adjustable length integrated retractable aider step 240 of a climbing stick. In this embodiment, the aider step 240 comprises a closed loop 242, such as described above with respect to FIGS. 5 and 6. A pull rope 244 comprises a pull loop 246 formed at a first, proximal end 248, and is secured to the closed loop 242 of the aider step 240 at a second, distal end 250. A stick body 252 comprises one or more holes 254 disposed along a longitudinal length of the stick body 252. As the pull rope 244 is pulled, retracting an interior end 256 of the closed loop 242 within the opening of the stick body 252 past one or more of the opening(s) 254 formed in the stick body, a pin 258 may be inserted restricting the available length of the closed loop 242 from extending beyond a bottom step 260 of the climbing stick. In this embodiment, for example, the greatest length of the closed loop 242 is available to extend the aider step 240 when no pin 258 is inserted and the closed loop 242 may be disposed solely within the lower step 260 of the climbing stick. Each discrete position further from the bottom step 260 along the longitudinal length of the stick body restricts an additional length of the closed loop 242 that is available to extend the aider step 240 below the lower step 260 of the climbing stick. In this manner, inserting the pin 258 in each hole 254 (or no hole) provides discrete available lengths for the aider step 240 to extend below the lower step 260 of the climbing stick.

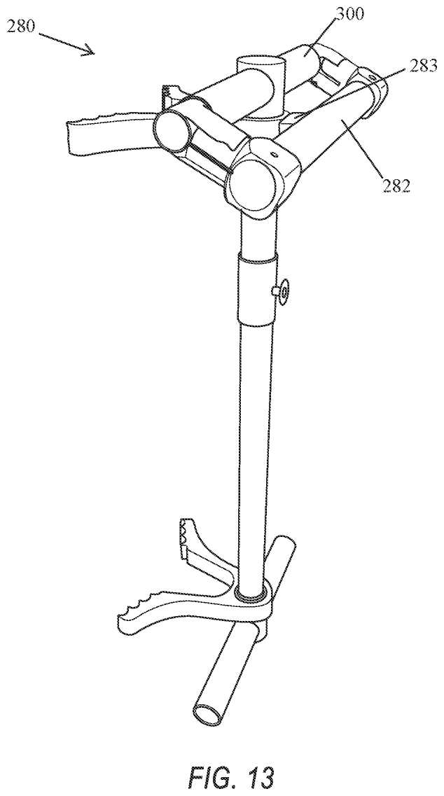

FIG. 13 is a perspective view of an embodiment of a climbing stick 280 including a removable, field installed angled shelf 282 attached directly to a climbing stick 280. In this embodiment, the angled shelf 282 is attached to the highest position climbing stick in a tree to provide a surface on which a user may stand or sit. The angled shelf 282 provides a larger surface available to tethered hunters (hunting while tethered and leaning from a tree) to set their feet. The angled shelf 282 may be installed on any one of a plurality of climbing sticks and does not require the use of a separate climbing stick with a dedicated platform or a separate platform disposed in the tree.

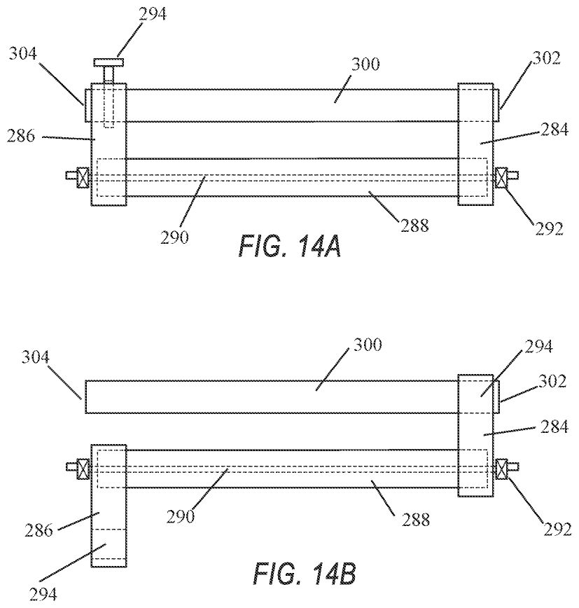

FIG. 14A is a top view showing an angled shelf 282 attached to a climbing stick 280, and FIG. 14B is a top view showing an angled shelf 282 partially attached to the climbing stick 280. In this embodiment, the angled shelf 282 comprises a pair of end brackets 284, 286 secured to opposing ends of a shelf member 288 (e.g., tube). The shelf member 288 comprises an interior opening 290 and an elastic cord 292 (e.g., a shock cord or bungee cord) disposed within the opening 290 of the shelf member 288.

The end brackets 284, 286 each comprise an opening 294 adapted to fit over a respective end 302, 304 of a top step 300 of a climbing stick. As shown in FIG. 14B, a first end bracket 284 can be attached to a respective first end 302 of the top step 300 of the climbing stick. The second end bracket 286 is pulled away from the opposite first end bracket 284 opposing the force of the elastic cord 292, rotated in place adjacent to a respective second end 304 of the top step 300 of the climbing stick, and slid over the second end 304 of the top step 300 of the climbing stick. The elastic cord 292 provides a compressive force on the opposing end brackets of the angled shelf 282 securing the angled shelf 282 to the top step 300 of the climbing stick. The angled shelf can then be secured via a pin 294.

To remove the angled shelf 282, the pin 294 is removed. One of the end brackets 286 is pulled away from a respective end 304 of the top step 300 of the climbing stick overcoming the compressive force of the elastic cord 292. The end bracket 286 is then rotated away from the end 304 of the top step 300 allowing the opposite end bracket 284 of the angled shelf to be removed from the opposing end 302 of the top shelf.

As shown in FIG. 13, once installed the angled shelf 282 is adapted to rotate downwardly from the top step until it rests against a surface of the climbing stick 280. The angled shelf 282 and/or the climbing stick 280 (e.g., on the standoff bracket or the stick body) can include one or more stop member 283 to restrict the rotation of the angled shelf 282 with respect to the top shelf 300 of the climbing stick 280 and provide a predetermined angle for the shelf 282.

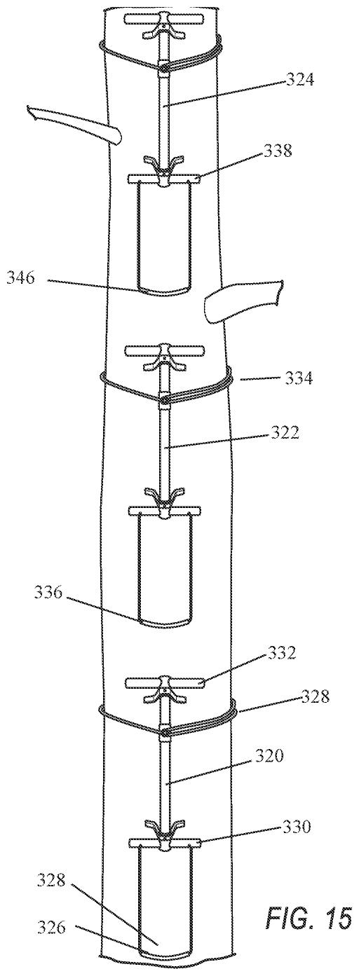

FIG. 15 is a front view of a plurality of climbing sticks 320, 322, 324 secured to a tree to provide a climbing aid to climb the tree. As shown in FIG. 15, each climbing stick may be installed on a tree with an aider step 326 extended increasing the effective length of each climbing stick and reducing the number of climbing sticks 320, 322, 324 needed to cover an equivalent height of the tree.

In one embodiment, for example, a first climbing stick may be installed in the tree by a user standing on the ground by wrapping a rope 328 around the tree and securing the rope 328 to a button of the climbing stick 320. The aider step 326 of the climbing stick 320 is extended providing a first step 328 in addition to the lower and upper steps 330, 332 of the climbing stick body. Then, standing on the upper step 332 of the first climbing stick 320, a second climbing stick 322 is installed onto the tree by wrapping a second rope 334 around the button of the second climbing stick 322, and the second aider step 336 is extended. Finally, the user climbs onto the second climbing stick 322 and installs a third climbing stick 324 onto the tree above the second climbing stick, and the third aider step 346 is extended. Standing on the top step of the second climbing stick 322 or lower step 338 of the third climbing stick, a shelf can be installed onto the top step of the third climbing stick. The user may then tether himself to the tree with his feet resting on the shelf installed on the third climbing stick.

The three climbing sticks shown in FIG. 15 is merely an example. Any number of climbing sticks may be installed in a tree, with or without the aider shelves extended depending on the particular circumstances.

What is claimed is:

1. A tree climbing stick comprising:
a stick body comprising an elongated member comprising an upper end, a lower end, and a longitudinal axis extending through the upper end and the lower end, the stick body comprising an interior opening extending through the lower end along at least a portion of the longitudinal axis;
a first standoff attached to and extending away from the stick body in a first direction;
a second standoff attached to and extending away from stick body in the first direction, the second standoff spaced from the first standoff and the first and second standoffs being adapted to engage a tree and maintain the stick body in a spaced relationship with the tree;
a step attached to the stick body and extending outwardly from the stick body, the step comprising a step interior opening extending through at least a portion of a length of the step;
a retractable aider step comprising a loop extending below the step and through the step interior opening, and a pull handle coupled to the loop within at least one of the stick body interior opening and the step interior opening, the pull handle extending from at least one of the step and the stick body,
wherein the aider step is adapted to be extended by a user pulling the loop and to be retracted by the user pulling the pull handle.

2. The tree climbing stick of claim 1, wherein the retractable aider step comprises a generally tubular aider step member disposed about a portion of the loop below the step.

3. The tree climbing stick of claim 2, wherein the generally tubular aider step member is adapted to maintain the loop in an open configuration.

4. The tree climbing stick of claim 1, wherein the pull handle is disposed at the proximal end of a pull rope, the pull rope comprising a distal end coupled to the loop within at least one of the stick body interior opening and the step interior opening.

5. The tree climbing stick of claim 4, wherein the pull rope extends around an interior structure of the tree climbing stick within the stick body opening between the distal end and the proximal end.

6. The tree climbing stick of claim 5, wherein the interior structure comprises a button pin extending through the stick body opening.

7. The tree climbing stick of claim 5, wherein the pull rope is adapted to retract at least a portion of the loop within the step interior opening and the stick body interior opening to retract the aider step adjacent to the step.

8. The tree climbing stick of claim 5, wherein the loop extends through a first hole through the step, the step interior opening, and a second hole through the step.

9. The tree climbing stick of claim 8, wherein the pull rope is coupled to the loop at the distal end of the pull rope, extends around a pin disposed within the stick body interior opening, and extends through a third opening in the step to the pull handle disposed at the proximal end of the pull rope.

10. The tree climbing stick of claim 1, wherein the pull handle comprises a portion of the loop extending from at least one of the step and the stick body.

11. The tree climbing stick of claim 1, wherein the stick body comprises a plurality of openings adapted to receive an adjustment pin to change a length of the retractable aider step available to extend from the step.

12. The tree climbing stick of claim 1, wherein the stick body comprises a telescoping adjustable stick body adapted to adjust the length of the stick body to one of a plurality of discrete lengths.

13. The tree climbing stick of claim 1, wherein a shelf comprises a shelf member and a pair of end brackets secured to opposing ends of the shelf member, the shelf member comprises an interior opening, and an elastic cord is disposed within the interior opening of the shelf member, the end brackets are adapted to engage opposing ends of a second step of the tree climbing stick.

14. A tree climbing stick comprising:
a stick body comprising an elongated member comprising an upper end, a lower end, and a longitudinal axis extending through the upper end and the lower end;
a connection member comprising a button coupled to and extending from the stick body in a first direction and a clip extending from the stick body in a second opposite direction;
a first standoff attached to and extending away from the stick body in the second direction;
a second standoff attached to and extending away from stick body in the second direction, the second standoff spaced from the first standoff and the first and second standoffs being adapted to engage a tree and maintain the stick body in a spaced relationship with the tree;
a first step attached to the stick body and extending outwardly from the stick body, the first step being disposed distally along the stick body longitudinal axis relative to the first standoff; and
a second step attached to the stick body and extending outwardly from the stick body, the step being disposed distally along the stick body longitudinal axis relative to the second standoff,
wherein the clip of the connection member is adapted to engage a button of a second tree climbing stick, and the first and second standoffs are adapted to nest with a respective first and second standoff of the second tree climbing stick when the tree climbing stick is coupled with the second tree climbing stick.

15. The tree climbing stick of claim 14, wherein the first standoff comprises a first pair of bracket members defining a first standoff opening and the second standoff comprises a second pair of bracket members defining a second standoff opening, wherein the first standoff opening is adapted to receive the first standoff of the second tree climbing stick and the second standoff opening is adapted to receive the second standoff of the second tree climbing stick.

16. The tree climbing stick of claim 14, further comprising a second tree climbing stick, the second tree climbing stick comprising:
a second stick body comprising a second elongated member comprising a second upper end, a second lower end, and a second longitudinal axis extending through the second upper end and the second lower end;
a second connection member comprising a second button coupled to and extending from the second stick body in a third direction and a second clip extending from the stick body in a fourth direction opposite the third direction;
a second stick first standoff attached to and extending away from the second stick body in the fourth direction;
a second stick second standoff attached to and extending away from second stick body in the fourth direction, the second stick second standoff spaced from the second stick first standoff and the second stick first and second standoffs being adapted to engage a tree and maintain the second stick body in a spaced relationship with the tree;
a second stick first step attached to the second stick body and extending outwardly from the second stick body, the second stick first step being disposed distally along the second stick body second longitudinal axis relative to the second stick first standoff; and
a second stick second step attached to the second stick body and extending outwardly from the second stick body, the second stick second step being disposed distally along the second stick body second longitudinal axis relative to the second stick second standoff,
wherein the second button is adapted be engaged by the clip of the connection member, and the first and second standoffs are adapted to nest with the respective second stick first and second standoffs of the second tree climbing stick when the tree climbing stick is coupled with the second tree climbing stick.

17. The tree climbing stick of claim 16, wherein:
the first standoff comprises a first pair of bracket members defining a first standoff opening, the first pair of bracket members comprising a first interior surface;
the second standoff comprises a second pair of bracket members defining a second standoff opening, the second pair of bracket members comprising a second interior surface;
the second stick first standoff comprises a second stick first pair of bracket members, the second stick first pair of bracket members comprising a first exterior surface substantially complementary to the first interior surface of the first pair of bracket members;
The second stick second standoff comprises a second stick second pair of bracket members, the second stick second pair of bracket members comprising a second exterior surface substantially complementary to the second interior surface of the second pair of bracket members.

18. The tree climbing stick of claim 16, wherein the first standoff is disposed adjacent to the second stick first step and the second standoff is disposed adjacent to the second stick second step when the tree climbing stick and the second tree climbing stick are coupled, wherein the second stick first step and the second stick second step restrict the first standoff and the second standoff from axial movement along the longitudinal axis when the when the tree climbing stick and the second tree climbing stick are coupled.

19. The tree climbing stick of claim 14, wherein the connection member comprises an integral button and clip.

20. The tree climbing stick of claim 14, wherein the first standoff and first step comprise an integral step and standoff device.

21. The tree climbing stick of claim 20, wherein the integral step and standoff device comprises a single, integral molded component.

22. A tree climbing stick comprising:
a stick body comprising an elongated member comprising an upper end, a lower end, and a longitudinal axis extending through the upper end and the lower end;
a connection member comprising an integral button and clip device coupled to the stick body, the integral button and clip device comprising a button extending from the stick body in a first direction and a clip extending around and away from the stick body in a second opposite direction;
a first standoff attached to and extending away from the stick body in the second direction;
a second standoff attached to and extending away from stick body in the second direction, the second standoff spaced from the first standoff and the first and second standoffs being adapted to engage a tree and maintain the stick body in a spaced relationship with the tree;
a first step attached to the stick body and extending outwardly from the stick body, the first step being disposed distally along the stick body longitudinal axis relative to the first standoff; and
a second step attached to the stick body and extending outwardly from the stick body, the second step being disposed distally along the stick body longitudinal axis relative to the second standoff,
wherein the clip of the integral button and clip device is adapted to engage a button of a second tree climbing stick.

23. The tree climbing stick of claim 22, wherein the first standoff and first step comprise an integral step and standoff device comprising a single, integral molded component.
